(19) United States
(12) Patent Application Publication
(10) Pub. No.: US 2004/0185145 A1
(43) Pub. Date: Sep. 23, 2004

(54) Food product and related method

(76) Inventors: Richard A. Ehrman, Beverly Hills, CA (US); Andrew I. Wolf, Los Angeles, CA (US)

Correspondence Address: MATTHEW A. NEWBOLES, STETINA BRUNDA GARRED & BRUCKER, Suite 250, 75 Enterprise, Aliso Viejo, CA, 92656, US

(21) Appl. No.: 10/742,157

(22) Filed: Dec. 19, 2003

Related U.S. Application Data
(63) Continuation-in-part of application No. 10/174,598, filed on Jun. 19, 2002.
Application No. 10/174,598 is a continuation of application No. 09/308,316, filed on Jul. 22, 1999, now abandoned.

(51) Int. Cl. A23C 9/12

(52) U.S. Cl. 426/34

(57) ABSTRACT

A food product and related method is provided in which the product is prepared in a manner that allows for optimum removal of food for consumption while retaining the delectable taste of the food and the overall easy storage and disposal of the food product. The food item is made by a method that includes extruding, forming or injecting a fruit substance so as to form the food item and then coating the food item with a release agent that substantially prevents the wrapper from adhering to the food item as the wrapper is removed from the food item. The food product may also be fortified with nutritional supplements or packaged in combination with other food products such as cheese-based or peanut butter-based foods.

### CROSS-REFERENCE TO RELATED APPLICATIONS

The present application is a continuation-in-part of U.S. Pat. application Ser. No. 10/174,598 entitled FOOD PRODUCT AND RELATED METHOD, filed Jun. 29, 2002, which is a continuation of U.S. Pat. application Ser. No. 09/308,316, entitled FOOD PRODUCT AND RELATED METHOD, filed Jul. 22, 1999.

### STATEMENT RE: FEDERALLY SPONSORED RESEARCH/DEVELOPMENT

Not Applicable

### BACKGROUND OF THE INVENTION

The present invention relates to food products and methods and, more particularly, to snack food products and related methods.

Snack foods are a staple part of the public's diet. Indeed, a not insubstantial amount of the public has displayed a penchant for “grazing” on small amounts of food throughout the day in lieu of eating regular meals. Not surprisingly, these conditions have fostered a burgeoning demand for a greater variety of snack foods, including snack foods such as fruit based snacks, that at least arguably have better nutritional value than certain other types of snack foods. Even more desirable are snack foods that can be made from all natural ingredients, and in particular, snack foods that are made entirely from fruit that can optionally include additional nutritional supplements, such as vitamins, minerals and/or medicinal compositions that can help bring about a desired therapeutic effect.

There likewise remains considerable demand for snack foods that have a relatively long shelf life, are fit for immediate consumption, and are compactly packaged for easy storage and disposal. To this end, snack food products often contain snack foods that are wrapped in relatively compact wrappers that may only contain a few items of snack food or even only one “bite sized” item.

Pre-existing snack food products do, however, have drawbacks in terms of their suitability for immediate consumption, especially over the useful shelf life of the snack food. Specifically, various snack food products tend to be made in a manner that makes the snack food unacceptably messy to remove from its wrapper and consume. This is especially troublesome when one considers the wide variety of different environmental conditions that a snack food is ordinarily exposed to over a period of time. By way of example, a fruit-based snack food typically has a tendency to undesirably adhere to its wrapper or packaging as the wrapper is removed from the snack food. Also exemplary of such snack foods include cheese-based and peanut butter-based foods that, despite their nutritional value and popularity amongst consumers, possess further characteristics, and in particular stickiness, that makes utilization of such products unappealing from a packaging standpoint. In this regard, a portion of the wrapper or packaging may cling or stick to the snack food or the portion may even tear away from the body of the wrapper so as to leave a remnant attached to the snack food. The consumer then may experience sticky hands in attempting to remove the wrapper, not to mention the tediousness and overall messy experience associated with removing the wrapper. The frustrated consumer may also ultimately discard some or all of the snack food, thereby wasting otherwise edible food.

In an attempt to address such shortcoming, a variety of snack food products, and in particular, fruit, cheese and/or peanut butter based snack food products have been formulated such that the same can be extruded or injected to thus enable the same to take a variety of forms and thus provide greater flexibility in terms of packaging. While food products such as cheese and peanut butter more readily lend themselves to such applications, there has been and continues to be a need for fruit-based products that can be formed, injected, or extruded to take a variety of configurations but at the same time retain all of the healthy properties associated with use of all natural fruit. In this respect, virtually all types of fruit-based snacks are supplemented with additional ingredients, agents, and the like, as well as artificial flavoring and preservatives to thus impart the desired properties of longer shelf life and greater flexibility with packaging. Such additives, however, detract from the all-natural aspect of the fruit products, and in essence defeat the entire purpose of providing a healthy, all-natural fruit-based food product.

Accordingly, it should be appreciated that there is a definite need for a more consumer-friendly, all-natural food product in which the consumer can relatively effortlessly remove the product from the wrapper and avoid having to deal with the unpleasantness of sticky hands and the unfortunate waste of the food product. There is additionally a need in the art for such a food product that can be readily formed, extruded and/or injected per a variety of food processing and manufacturing techniques to thus enable the food product to be utilized in a wide variety of packaging configurations, as well as possess a long shelf life. There is still further a need in the art for such a food product that can further be readily made and packaged in combination with other well-known food products, including cheese-based products and peanut butter-based products, and further can be fortified with a variety of nutritional supplements, such as vitamins, minerals, nutraceuticals and/or therapeutic agents to thus serve as a base within which such nutritional supplements can be administered.

### BRIEF SUMMARY OF THE INVENTION

The present invention, which addresses the aforementioned deficiencies, is embodied in an all-natural food product and related method that is prepared in a manner that allows for optimum removal of food for consumption while retaining the delectable taste of the food and the overall easy storage and disposal of the food product. The food product and related method of the present invention can further advantageously be formed, injected and/or extruded, either alone or with other food products such as cheese-based and peanut butter-based products, as well as can be supplemented with nutritional supplements, such as vitamins, minerals, nutraceuticals, and/or therapeutic agents, such as antihistamines, H2-antagonists or other medicinal agents that are operative to impart a desired therapeutic effect.

The food product includes a food item having a primary fruit substance and a release agent that is associated with the outer surface of the food item such that it substantially prevents the packaging within which the food product is contained (i.e., the wrapper) from adhering to the food item as the packaging (i.e. wrapper) is removed from the food item. Consequently, the packaging wrapper can be removed from the food item without a portion of the wrapper clinging or sticking to the food item and without any portion of the wrapper tearing away from the body of the wrapper and attaching itself as a remnant to the food item. Thus, the consumer does not have to contend with the tediousness of detaching the wrapper from the food item or the messy experience of sticky hands.

In more detailed aspects of the invention, the wrapper includes first and second opposing segments that together form a peelable seal around the food item. Further, the first segment has an inner layer of polyethylene connected to an outer layer of polyester, while the second segment has an inner layer of polyethylene connected to an outer layer of a thermally formable material, such as nylon. Moreover, the release agent is one or more fruit powders or a composition that includes a fruit powder and a flour and the release agent further coats the, outer surface of the food item. As an alternative to a fruit based release agent, an appropriate natural or synthetic oil, such as MIGLYOL 812, coats the outer surface of the food item. As still another alternative, in lieu of the release agent, the food item is characterized by a baked outer surface that provides an anti-stick barrier which substantially prevents the wrapper from adhering to the food item as the wrapper is removed from the food item.

In other detailed aspects of the invention, the food item is made by a method that includes extruding a fruit substance so as to form the food item and then coating the food item with a release agent that substantially prevents the wrapper from adhering to the food item as the wrapper is removed from the food item. Alternatively, the fruit substance can be injected or formed according to a desired shape or configuration. The coating is in turn effectuated by a freeze drying process. Alternatively, in lieu of coating the food item with the outer surface of the food item with a release agent, the method includes baking the outer surface of the food item as to provide the aforementioned anti-stick barrier. In further refinements, the food product may be fortified with nutritional supplements, such as vitamins, minerals, nutraceuticals, and one or more therapeutic agents to thus impart a desired therapeutic benefit. Such food product may further be co-packaged with other food products, and in particular cheese-base food products and/or peanut butter-based products insofar as the same complement the food product of the present invention in terms of food properties, related manufacturing techniques utilized to manufacture such food products (e.g., injection/extrusion) consumer demand for such complementary products (e.g., peanut butter and jelly).

Other features and advantages of the present invention should become more apparent from the following description of the preferred embodiments, taken in conjunction with the accompanying drawings, which illustrate, by way of example, the principles of the invention.

### BRIEF DESCRIPTION OF THE DRAWINGS

FIG. 1 is a perspective view of the food product of the present invention.

FIG. 2 is an enlarged side cross-sectional view of the food product, taken substantially along lines 2-2 in FIG. 1.

FIG. 3 is a perspective view showing the food product of FIG. 1 as partially opened by the consumer at its flap.

FIGS. 4a, 4b and 4c are process flow diagrams, each depicting a procedure for making the food product.

### DETAILED DESCRIPTION OF THE INVENTION

With reference now to the exemplary drawings, and particularly to FIGS. 1-3, there is shown a food product 10 which includes a food item 12 that is snugly contained within a wrapper 14 and has a release agent 16 situated between the food and the wrapper. While it can be one or more of a variety of edible materials, the food item is preferably a fruit substance that is sufficient in quantity to constitute a snack for the consumer. In the case of a fruit substance, the ingredients of the food item include principally dried fruit and natural or artificial food coloring, natural or artificial flavors and, optionally, sweeteners and natural or artificial preservatives, although artificial ingredients are generally disfavored. Typical natural preservatives are citric acid or lemon juice, and conventional artificial preservatives include potassium sorbates, sodium benzoate, and other appropriate preservatives that retard or prevent spoilage of the fruit substance. Additionally, the fruit substance preferably, but not necessarily, includes suitable grains, flours or starches or combinations thereof, such as rice flour or a rice based composition.

The food product 10 may additionally be fortified with vitamins, minerals, nutraceuticals, and/or compositions that are operative to impart a desired a therapeutic benefit. With respect to the latter, it is contemplated that any of a variety of medicinal agents, such as antihistamines, H-2 antagonists, anti-tussive agents, pain relievers, such as aspirin, ibuprofen, acetaminophen and the like, plus any of a variety of medications well-known to those skilled in the art may be readily incorporated into such food product. Exemplary of those types of additives suitable for use in fortifying the food product 10 of the present invention include those mineral and nutritional supplements produced by Pharmachem Laboratories, Inc. of Kearny, N.J. Additionally, it is expressly contemplated that the food product 10 may include herbal remedies, such as those proprietary herbal formulations developed by East West Medical Research Institute of Los Angeles, Calif., as well as any of a variety of other herbal preparations currently known or later developed. Along these lines, it will be readily appreciated that the amount of vitamins, minerals, nutraceuticals, and/or therapeutic agents will be added in amounts relative the food product that can be easily determined by techniques well-known in the art. Accordingly, it should be recognized at the outset that the food product 10 of the present invention may be particularly well suited to serve as a carrier for such nutritional supplements/therapeutic agents.

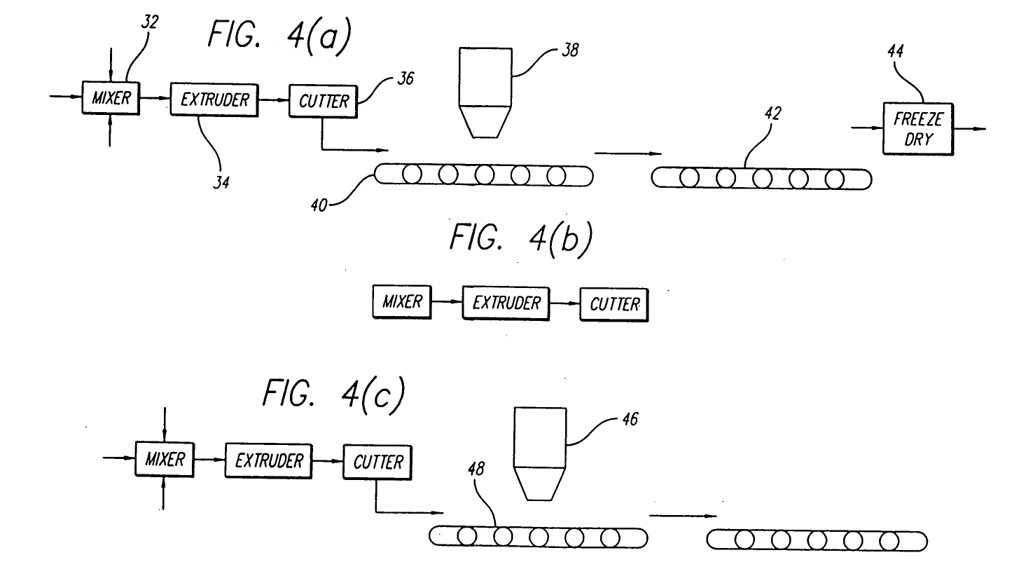

The food item 12 is formed by a conventional mixing and extrusion process utilizing mixing and extrusion equipment 32 and 34 that is common in the food industry, such as Vemag extrusion equipment available from Robert Reiser & Co., Inc. of Canton, Mass., and thereby assumes the familiar tubular shape. After the extrusion process, a suitable cutter 36 may also be used to cut appropriately size food items as shown in FIG. 4. In this regard, where a fruit substance serves as the food item, the fruit is dried fruit, such as apples, dates, apricots, cherries, grapes and strawberries, and advantageously has a moisture content of about 16% to about 25% by weight. Once a particular fruit is selected, one can select one or more natural or artificial flavorings, sweeteners and colors that enhance or complement the taste of the fruit. Moreover, for a fruit substance, the dried fruit and other ingredients are mixed together and extruded at room temperature (i.e., about 65° to about 70° F.). As should be recognized, however, in the preferred embodiment the food product 10 will omit any type of artificial ingredients, and in particular artificial flavorings and preservatives, insofar as the same will detract from the all-natural and healthy aspect of the food product 10. Additionally, it will be readily appreciated to those skilled in the art that although capable of being formed by conventional extrusion processes, it should further be appreciated that the food product 10 may be made by injection processes well-known to those skilled in the art. In this respect, it is contemplated that the ability to inject the food stuff may be exceptionally desirable in certain applications, particularly when the food product 10 is co-packaged with other food products, such as cheese-based products and peanut butter-based products, discussed more fully below.

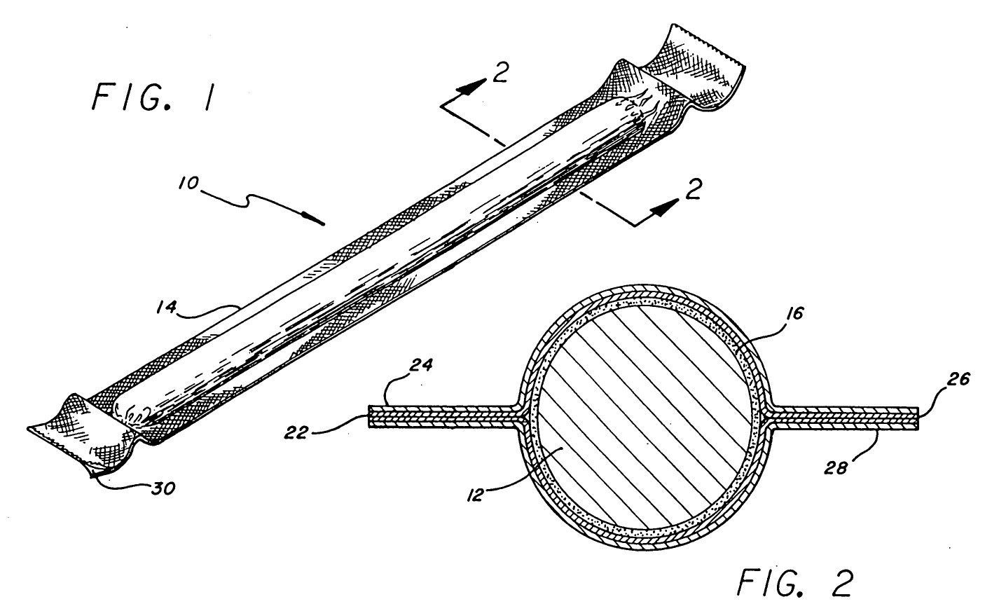

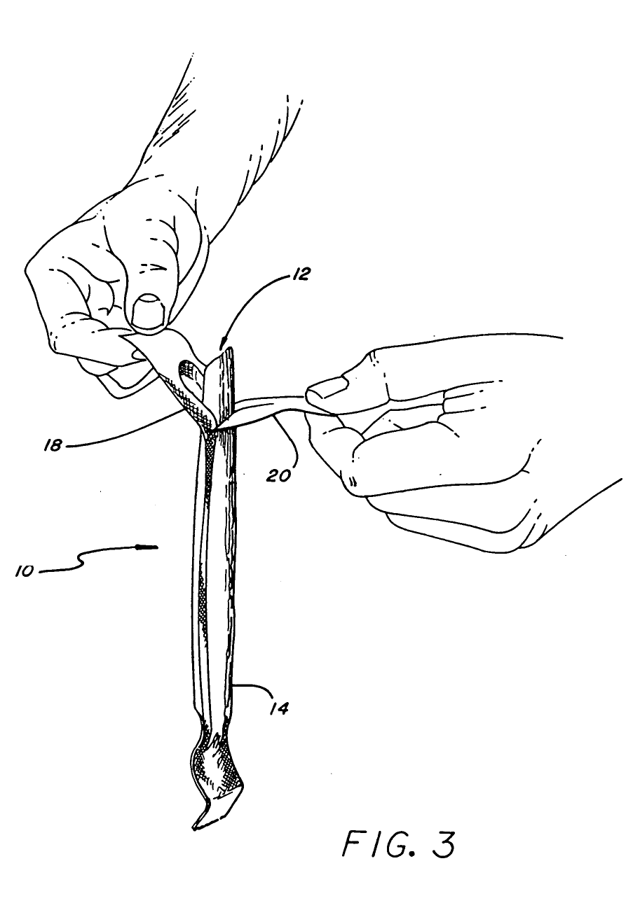

The wrapper 14 includes two segments 18 and 20 that are together particularly adapted for containment of the food item 12 and relatively easy access to the food item. The wrapper 14 is also advantageously made of a suitable material which snugly contains the food item 12 and facilitates prompt and easy removal of the food item from the wrapper when consumption is desired. To this end, as shown in FIGS. 2-3, two segments 18 and 20 are joined together around the food item by utilizing conventional thermal pressurization and seal food packing equipment, such as thermal form and fill machines available from Multivac, Dixie Union, and Tiromat. Specifically, the segment 18 includes an approximately 2.0 mils thick inner layer 22 or high octane, linear low density polyethylene (“LLDPE”) that is laminated to an about 50 gauge polyester outer layer 24 made of polyester or a biaxially oriented polypropylene. Further, an oxygen barrier coating, such as that available under the trademark Saran, is sandwiched between the layers 22 and 24 so as to render the segment 18 less permeable. The segment 20 in turn includes a similar inner layer of LLDPE 26 and an about 5.0 mils thick outer layer 28 of a suitable thermally formable material, such as nylon or cast polypropylene. The use of such an outer layer 28 for segment 20 helps ensure that the wrapper will closely conform to the shape of the food item. Correspondingly, the outer layer 24 provides for better adhesive and sealing characteristics for the wrapper 14. Similarly, an oxygen barrier coating, such as evoh, is sandwiched between the layers 26 and 28 to lessen permeability. In lieu of LLDPE, the inner layers 22 and 26 can be made of any other polyethylene or an ionomer that has the requisite sealing characteristics.

As shown in FIGS. 1 and 3, the two segments 18 and 20 are peelable and together create a seal that effectively extends around the food item 12, while also defining an opening of flap(s) 30 at the top end of the wrapper 14 above where the seal terminates. This facilitates peeling without prematurely exposing the food item. The snack food product 10 is then opened by grasping the top portion of each segment at the flap and peeling each segment back relative to the other. It will be appreciated that a variety of other materials can be utilized to create a wrapper having suitable sealing and peelability characteristics.

In accordance with another feature of the invention, the release agent 16 is associated with the outer surface of the food item 12 so as to better permit easy removal of the wrapper 14 from the food item and at least substantially prevent any portions of the wrapper from undesirably adhering to the food item while the segments 18 and 20 are peeled away from each other. Consequently, the food item can be removed and consumed without having to individually remove separate portions or remnants of the wrapper from the food item. Moreover, the consumer can also consume the food item without having to contend with sticky hands or an unseemly mess.

The release agent 16 is advantageously a substance that will not detract from the texture and delectable taste of the food item 12, and will provide a barrier between the wrapper 14 and food item 12 that prevents undesirable adherence of the wrapper to the food item during removal of the food item. In this regard, a preferred substance is an appropriate fruit powder or a composition of a fruit powder with a grain or flour, such as rice flour, which effectively coats the food item. Representative examples of such fruit powder including the following, all of which are currently available from Armour Food Company:

| TYPE | PRINCIPLE INGREDIENTS | PERTINENT PROPERTIES |
|---|---|---|
| Spray Dried Concord | Concord grape solids and | Moisture: 4.0% maximum |
| Grape | maltodextrine | pH: 3.4 +/− 0.2 |
| | | Grape Solids: 50% |
| | | minimum |
| Spray Dried Concord | Concord grape solids and | Moisture: 4.0% maximum |
| Grape | maltodextrine | pH: 3.4 +/− 0.2 |
| | | Fruit Solids: 50% |
| | | maximum |
| Spray Dried Apricot | Apricot puree and, optionally, | Moisture: 3.0% maximum |
| | less than 2% silicon dioxide | Granulation: 100% through |
| | (anti-caking agent) | U.S. #1 |
| Spray Dried Sour Cherry | Sour cherry, juice solids, | Moisture: 4.0% maximum |
| | maltodextrine and, optimally, | pH: 10% |
| | less than 2% silicon dioxide to | Solution: 4.0% +/− 0.2 |
| | prevent caking. | |

A representative example of a grain or flour suitable for combination with any of the aforementioned types of fruit powder is rice flour presently available from California Natural Products of Lathrop, Calif. Such flour typically has a moisture content of about 12% by weight and is relatively finely granulated. Such a combination also preferably yields a composition that is about 40 to 60% by weight rice flour. The composition can also include more than one type of fruit powder.

The particular type of fruit powder or fruit powders used will partially depend on the type of fruit substance that makes up the food item 12, because this considerably affects the texture and delectability of the food items. Representative examples of the fruit powder(s) used for representative fruit substances are set forth below:

| FRUIT SUBSTANCE | |
|---|---|
| Principal Ingredients | FRUIT POWDER |
| Dates, pears, bananas, apricots, natural | Apricot |
| color and flavor, lemon juice | |
| Dates, pears, bananas, grapes, natural color | Grape |
| and flavor, lemon juice | |
| Dates, pears, bananas, cherries, natural | Cherry |
| color and flavor, lemon juice | |
| Dates, pears, bananas, strawberries, natural | Strawberry |
| color and flavor, lemon juice | |
| Dates, apricots, natural color and flavor, | Apricot |
| lemon juice | |

It will be appreciated that any number of other fruits or combinations thereof can also be used depending on consumer preference and other well understood factors. For instance, in the first example above, one could substitute apples for dates.

In order to better ensure that the release agent 16 in the form of fruit powder(s) or a composition of fruit powder(s) and grain or flour adequately covers the food item 12, copious amounts of the fruit powder(s) or a composition thereof are applied to the food item 12 via a powder applicator 38 that drops fruit powders vs. aforementioned compositions onto the food item as it passes along a conveyor 40 (See FIG. 4a). Then, the food item is carried along a vibrating conveyor 42 and is thereafter exposed to a quick freeze drying process in processor 44 such that the fruit powder(s) or composition effectively forms a coating around the outer surface of the food item. Preferably, the freeze drying process occurs at a temperature of about minus 20° F. over a continuous two-minute period for each food item. The freeze drying process not only coats the food item 12, and thereby at least substantially prevents stickiness, but also tends to substantially impede absorption of the release agent 16 into the food item 12 over the course of the useful shelf life of the food product 10. Suitable equipment for carrying out this procedure is a powder applicator available from Accutron and standard food freeze drying equipment such as the available from BOC Gas. The powder applicator typically has a sifter and hopper that gravity-feeds the release agent 16 onto the food items 12 as they pass along the conveyor (See, FIG. 4a).

By way of an alternative embodiment, as an alternative release agent, the outer surface of the food items may be coated with an appropriate natural or synthetic oil, including the natural oil known as MIGLYOL 812 which is a mixed acid triglyceride of fractionated coconut fatty acids C₆-C₁₀. In that event, the oil would be spray coated in atomized droplets or a fine mist onto the food items 12 as they pass along conveyor 48 via an oil applicator 46 (See FIG. 4c).

A further alternative embodiment of the food product will now be described. Specifically, in lieu of the release agent 16, the food product 10 can include the wrapper 14 and food item 12 above. However, in this instance, a special baking process is used to create an outer surface that forms an anti-stick barrier which substantially prevents the wrapper from adhering to the food item as the wrapper is removed from the food items. (See FIG. 4c). To this end, a suitable convection oven is preferably used that is set at a temperature of about 150 to about 190° F. and thereby slowly bakes the outer surface of the food item over a period of about 20 to about 60 minutes. Moreover, as part of the drying process, a substantial flow of air is circulated around the food item. Suitable convection ovens include ovens made by MacTavish Machine Manufacturing Company of Richmond, Va. and Proctor and Schwartz.

Irrespective of the variety of manners by which the food product 10 of the present invention can be formed, it should be appreciated that the same, by virtue of the fact that food product 10 can be formed, extruded and/or injected to take a variety of shapes and configurations, the food product 10 of the present invention advantageously lends itself for co-packaging with other related food products. Specifically, it is contemplated that the food product 10 of the present invention can be co-manufactured and packaged with cheese-based food products and/or peanut butter-based food products. In this respect, such food products (i.e., cheese and peanut butter) have similar food properties that complement the food product 10 of the present invention and readily lend themselves to cheese/fruit combinations and peanut butter/fruit combinations, as considered desirable by consumers. In addition, by virtue of the fact that the food product 10 may be fortified with vitamins, minerals, nutraceuticals, or other therapeutic agents, the food product 10 may serve as a basis to introduce such nutritional supplements/therapeutic agents that typically may not be administered alone via a cheese-based and/or peanut butter-based food product. Accordingly, it is expressly contemplated that the food product 10 of the present invention may be utilized not only as a stand alone food product, but also to complement other food products and further introduce such additional nutritional supplements/therapeutic agents via an all natural, all fruit food product that has not heretofore been available.

Although the invention has been described in detail with reference only to the presently preferred devices and method, those of ordinary skill in the art will appreciate that various modifications can be made without departing from the invention. Accordingly, the invention is defined only by the following claims.

What is claimed is:

1. A food product comprising:
a. an extruded cheese-based food item;
b. an extruded fruit-based food item having moisture content of at least about 16% by weight;
c. a release agent comprising a fruit powder having a moisture content not greater than 4.0% by weight, said release agent entirely coating said extruded fruit-based item; and
d. a wrap formed from a polymer material sealingly engaged about said extruded cheese-based food item, said extruded fruit-based food item and said release agent.

2. The food product of claim 1 wherein said release agent further comprises a flour having a moisture content of about 12% by weight or less, said flour being present in a ratio by weight relative said fruit from about 2.0:3.0 to 3.0:2.0.

3. The food product of claim 1 wherein said flour comprises rice flour.

4. The food product of claim 1 wherein said extruded fruit-based food item is formed from a fruit selected from the group consisting of apples, dates, apricots, cherries, grapes, strawberries, and combinations thereof.

5. The food product of claim 1 wherein said extruded fruit-based food item possesses a moisture content from approximately 16% to approximately 25% by weight.

6. The food product of claim 1 wherein said fruit powder comprises a powder coating freeze dried about said extruded fruit product.

7. A food product comprising:
a. an extruded peanut butter-based food item;
b. an extruded fruit-based food item having moisture content of at least about 16% by weight;
c. a release agent comprising a fruit powder having a moisture content not greater than 4.0% by weight, said release agent entirely coating said extruded fruit-based item; and
d. a wrap formed from a polymer material sealingly engaged about said extruded peanut butter-based food item, said fruit-based food item and said release agent.

8. The food product of claim 7 wherein said release agent further comprises a flour having a moisture content of about 12% by weight or less, said flour being present in a ratio by weight relative said fruit from about 2.0:3.0 to 3.0:2.0.

9. The food product of claim 7 wherein said flour comprises rice flour.

10. The food product of claim 7 wherein said extruded fruit-based food item is formed from a fruit selected from the group consisting of apples, dates, apricots, cherries, grapes, strawberries, and combinations thereof.

11. The food product of claim 7 wherein said extruded fruit-based food item possesses a moisture content from approximately 16% to approximately 25% by weight.

12. The food product of claim 7 wherein said fruit powder comprises a powder coating freeze dried about said extruded fruit product.

13. A food product comprising:
a. an extruded fruit-based food item having a moisture content of at least about 16% by weight;
b. a release agent comprising a fruit powder having a moisture content not greater than 4.0% by weight, said release agent entirely coating said extruded fruit-based food item; and
c. wherein said fruit-based food item is fortified with nutritional supplements selected from the group consisting of a vitamin, a mineral, a nutraceutical, and a therapeutic agent.

14. The food product of claim 13 wherein said therapeutic agent is selected from the group consisting of an herbal preparation and a pharmaceutical composition.

15. The food product of claim 14 wherein said pharmaceutical composition is selected from the group consisting of an antihistamine, an H-2 antagonist, an anti-tussive agent, and a pain reliever, said pain reliever being selected from the group consisting of aspirin, ibuprofen and acetaminophen.

16. The food product of claim 1 wherein said cheese-based product and said fruit-based product are formed by injection.

17. The food product of claim 7 wherein said peanut butter-based food item and said fruit-based food item are formed by injection.
